(19) United States
(12) Patent Application Publication
(10) Pub. No.: US 2009/0187822 A1
(43) Pub. Date: Jul. 23, 2009

(54) SYSTEM AUDITING FOR SETUP APPLICATIONS

(75) Inventors: Amador C Abreu, Kirkland, WA (US); Nathan W Jeffery, Everett, WA (US); Tyler D Moeller, Redmond, WA (US); Jeffrey A Stone, Redmond, WA (US); Jason S Jensen, Lake Forest Park, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/018,235

(22) Filed: Jan. 23, 2008

(51) Int. Cl. G06F 9/44; G06F 3/048

(52) U.S. Cl. 715/700; 717/126

(57) ABSTRACT

A verification architecture for verifying that a setup application (or installer) for installing, modifying, repairing and uninstalling an application properly deploys the desired features in complex computing environments. The extensible framework allows all facets of an API to be customized for the needs of any software product. An explorer user interface facilitates viewing and managing the data that represents the behavior of the installer in the targeted environment. The explorer allows the user to make changes either on a single item or a large number of items all at once. The explorer can display the differences between two different executions of the tool, and then allow the user to view each individual difference and update the expected behavior in the environment based on the data presented. This solution applies to businesses that plan on releasing a software product which include multiple configurations and/or is intended to deploy on multiple platforms.

### BACKGROUND

The seamless loading and use of software by the customer is critical to the success of a vendor software product. Software products are becoming increasingly complex in the number of features and modules that should be installed across multiple operating systems, languages, and hardware architectures. This responsibility is placed on the software installer to manage and consistently install the correct pieces based on a given hard and software environment. For example, the application software installed on a computing system that employs older-style hardware (e.g., CPU, hard drives, graphics adapters, etc.) and operating system can be different than the software installed on the latest computing system running the latest hardware and software operating system. Additionally, manufacturers are developing and selling a wide variety of new devices (e.g., mobile devices) to the consumer. The software developed and utilized today needs to be able to support the wide variety of computing devices and platforms. Thus, the installer must be designed and tested to behave differently and correctly in each of these configurations through the installation of different files, directories, registry entries, services, etc., all scenarios of which should be tested and verified before final delivery to the customer or end-user.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is a complete end-to-end solution (or tool) for verifying that a setup application of a software product properly deploys the desired features in complex computing environments. The setup application (or installer) is a deployment mechanism or process that includes functionality for installing, repairing, modifying and uninstalling application features. This solution is applicable to businesses that plan on releasing a software product which can include multiple configurations and/or is intended to install on multiple platforms. The architecture is an extensible framework which allows all facets of an API to be customized for the needs of any software product.

The architecture also includes a graphical user interface (UI) (referred to as an explorer), which is a standalone executable file for viewing and managing the data that represents the behavior of the installer in the targeted environment. The explorer allows the user to make changes either on a single item or a large number of items all at once. The explorer facilitates the browsing of system state information which may have originated from a computer (which may or may not be currently running), or from a database which stores the system state information that is defined by a specification. This state information can include information concerning files, directories, registries, services, metabase entries, or any other serializable system property. The explorer also facilitates management of this state information.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented verification system in accordance with the disclosed architecture.

FIG. 2 illustrates an extensible set of the items provided by the auditing library for verification of the quality of an application deployment.

FIG. 3 illustrates a method for an exemplary test case.

FIG. 4 illustrates a method of testing using an exemplary detailed end-to-end simple test case.

FIG. 5 illustrates a general test case method.

FIG. 6 illustrates a detailed test case method of comparing state elements using excluded items.

FIG. 7 illustrates that the comparison of the current system state to the expected system state is saved as a dictionary of system state.

FIG. 8 illustrates a system for managing application test deployment across multiple different platforms.

FIG. 9 illustrates a method of verifying application deployment on a computing system.

FIG. 10 illustrates an exemplary explorer UI for interacting and configuring the verification component.

FIG. 11 illustrates a block diagram of a computing system operable to execute application test deployment and verification in accordance with the disclosed architecture.

### DETAILED DESCRIPTION

The disclosed verification architecture is a generic test platform for application setup that verifies the state of a machine after the execution of a setup application. The architecture provides a setup mechanism for creating, editing, and maintaining state information, facilitates adaptability from one setup application to another setup application, and built-in support for standard types of tests as well as the ability to create unique testing scenarios that can be expanded to run on various test infrastructures. The auditing library facilitates an end-to-end solution for verifying the setup of a software product. The architecture also includes a graphical user interface (UI) (referred to hereinafter as the explorer) that facilitates the administration of information defined by a setup specification.

The verification architecture represents a quick and efficient approach to managing and monitoring the quality of an application installer so that issues in the setup process can be detected immediately rather than at the end of a product cycle (or worse, after the product ships). Moreover, this solution can easily be packaged and sold to customers, and due to solution extensibility, serve as a foundation for providing solutions to yet unidentifiable problems to come.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

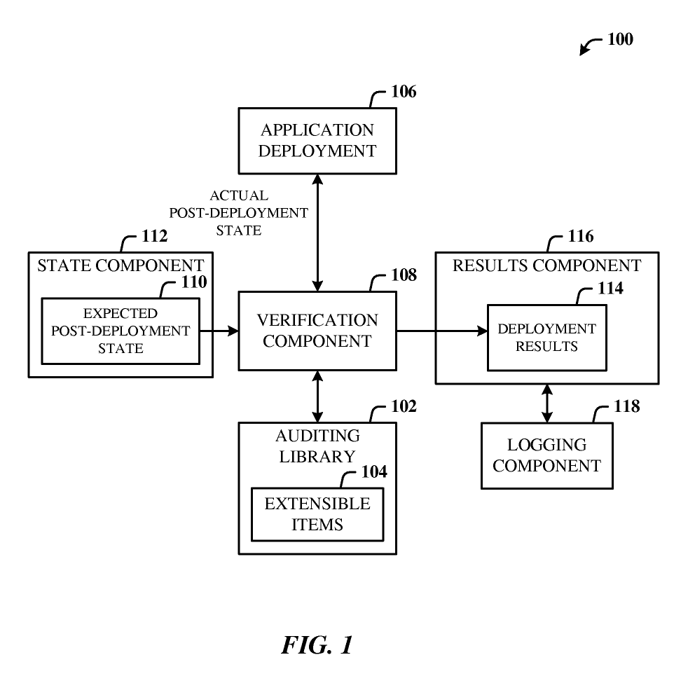

FIG. 1 illustrates a computer-implemented verification system 100 in accordance with the disclosed architecture. The system 100 includes an auditing library 102 of extensible objects 104 (referred to as state elements, or specifically labeled as StateElement in one implementation) for automating verification and quantifying machine states of a deployment (e.g., test) of an application 106. The overall deployment process or mechanism as defined herein includes one or more of application install, modification of application features or feature modules after the install, repair of the install and/or application features or feature modules, and uninstall of the application in its entirety or application features or feature modules separately.

A verification component 108 is provided for running a setup test and then verifying the deployment of the application by comparing actual post-deployment state to expected post-deployment state 110 as defined via a state component 112. The verification component 108 combines one or more items of the auditing library to verify the test deployment. The verification component 108 then generates deployment results 114 via a results component 116, the results 114 including logged messages (in a log via a logging component 118) and stored messages related to the deployment process. The logged messages can be related to results of the setup and results of the test case. The auditing library 102 can be embodied as a DLL (dynamic link library) file for adaptability across different environments.

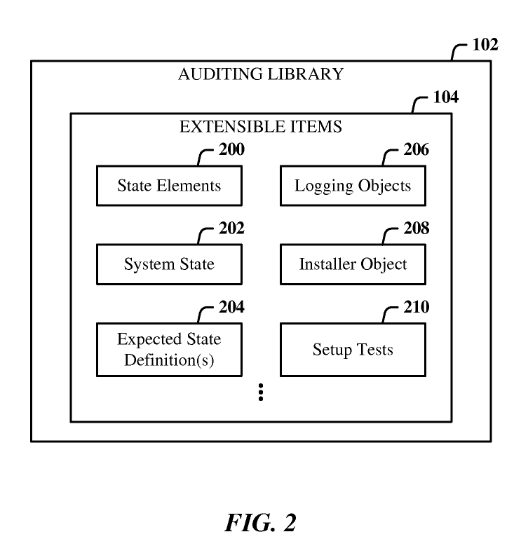

FIG. 2 illustrates an extensible set of the items 104 provided by the auditing library 102 for verification of the quality of an application deployment. The deployment auditing library 102 provides the items for automating the verification of installation, modification (e.g., adding and removing features), repair, and uninstallation of a software product. The verification process employs the auditing library 102 to capture post-deployment state of a computer and compare the post-deployment state against an expected post-deployment state which is created at runtime depending on the features installed and the conditions under which the items were installed.

The auditing library 102 includes state element items 200, system state items 202, an expected state definition 204, logging object 206, installer object 208, setup tests 210, and other extensible items, as desired.

The state element items 200 represent a particular item on a computer that is to be verified. Any aspect of the machine can be represented as a state element. It is assumed that the data is serialized for the state element. This does not, however, mean that objects must be reconstructable from the serialized string; rather, the properties that are to be represented in the state element are serializable. Examples of state elements 200 include, but are not limited to, FileStateElement (representing a file on a machine), RegistryValueStateElement (representing a registry value on a machine), ServiceStateElement (representing a service on a machine), EventStateElement (representing an event on a machine), WMIStateElement (representing Window Management Instrumentation extension state on a machine), BinarySigningStateElement (representing a binary sign on a machine), ActiveDirectoryStateElement (representing an Active Directory™ state on a machine), IISMetaBaseStateElement (representing a Internet Information Services™ internal database state on a machine), and ConfigFileChangeStateElement (representing data that should change inside a configuration file).

Each of the state elements 200 also is associated with a ParentStateElementType, which is derived from a state element. A ParentStateElementType is either the type of a ParentStateElement or “None”. A ParentStateElement contains additional flags which change the way the library 102 handles the elements 200 that are under the parent. Examples of a ParentStateElement include, but are not limited to DirectoryStateElement (representing a directory on the file system on a machine) and RegistryKeyStateElement (representing a registry key on a machine).

Each of the state elements 200 is unique, which is defined by the element's parent (if there is one), Element type, and element Name. For example, a file (C:\library.dll) can be uniquely identified as a FileStateElement called ‘library.dll’ which has a DirectoryStateElement named (C:) as its parent. Note that an instance of the parent does not have to actually exist.

The system state items 202 are a collection of state elements that represent the state of a system at a particular point in time. Examples of system state items include, but are not limited to, CurrentSystemState (represents the current machine), RemoteSystemState (represents a remote machine), ExpectedSystemState (represents the state of a system that is generated by a setup spec), and SavedSystemState (a stored state (partial or full) of a machine at any given time).

The expected state definition 204 can be implemented as an XML file and/or a database (e.g., SQL-structure query language) that contains the information defined for all files, directories, registries, services, and metabase entries, and all expected properties, as well as file contents which will be modified during the deployment. For example, the expected state definition 204 contains information about the computing platform for which the entries can be verified such as operating system and processor type (e.g., x86, x64, etc.). The expected state definition 204 also includes information for each entry related to if the entry should be verified for any of the deployment actions (e.g., install, modify, repair and uninstall). Further included in the expected state definition 204 is information about the type of the expected state definition 204, a parent to the expected state definition 204, and references to other expected state definitions, if utilized. The expected state definition 204 essentially provides the constraints for each entry, for example, a file should only be installed on an x86 platform.

The expected state definition 204 implements a definition interface and stores the data used to generate the ExpectedSystemState for the tests. Examples of expected state definitions 204 include, but are not limited to, AccessGT (for Access™ based setup specs), SqlGT (for SQL-based setup specs), fileGT (for a file-based setup specs) and XmlGT (for XML-based setup specs).

Logging objects 206 derive from an ILogger class which allows messages to be passed to the log associated with the logging component 118 of FIG. 1. Examples of logging objects 206 include, but are not limited to, a logger that sends logging information to an automation test framework, a logger that sends logging information to a file), and a logger that sends information to a text box).

The installer object 208 performs different tasks such as running setup applications by processes (such as building a command line) based off of properties that have been passed, running a method Run( ) (which contains the logic to install/uninstall the given set of features) and/or implement a UI solution, and associates itself with an expected state definition and tracks which products and features were installed or removed. The installer object 208 then uses this information to query the expected state definition to retrieve an ExpectedSystemState item based on the changes expected to have occurred as a result of the deployment.

The setup tests item 210 is a component that combines one or more of the items mentioned to verify the setup. Each setup test derives from SetupTest and implements a Run( ) method and a Verify( ) method. More specifically, the SetupTest calls a delegate which by default points to the Run( ) method in the installer. Before execution, the SetupTest can point to a completely different method to execute; for example, install A, but cancel the install midway, install B, uninstall B, install A, and then re-install B. This has the result of A and B being installed. As long as the installer thinks the platform should be setup in the same way as what happens, the test will pass. In one implementation, the library.dll includes three different kinds of tests; however, users can derive custom tests from this class.

The tests include a simple test case (SimpleTestCase) where the test retrieves the ExpectedSystemState from the expected state definition and checks to ensure all of the state elements were installed or removed as desired. A second test is a thorough test case (ThoroughTestCase) where a pre-scan of the system is performed prior to calling the Run( ) method. Once the Run( ) method has finished, another scan of the machine is performed to find all changes from the first scan. The difference is then compared with the ExpectedSystemState. The ThoroughTestCase can detect when “extra” artifacts (e.g., code, events, etc.) were installed on or removed from the machine that were not expected. A third test (ServiceAndEventTest) is intended for build verification level testing where the test runs the installer and only checks to determine if expected services are in the correct state and that the appropriate events were entered into the event log.

Test cases can be packaged as part of the deployment mechanism. Customized test cases can also by created by the end user. This capability also applies to other aspects of the disclosed architecture such as state elements, system state, expected state definitions, installers, loggers, and so on.

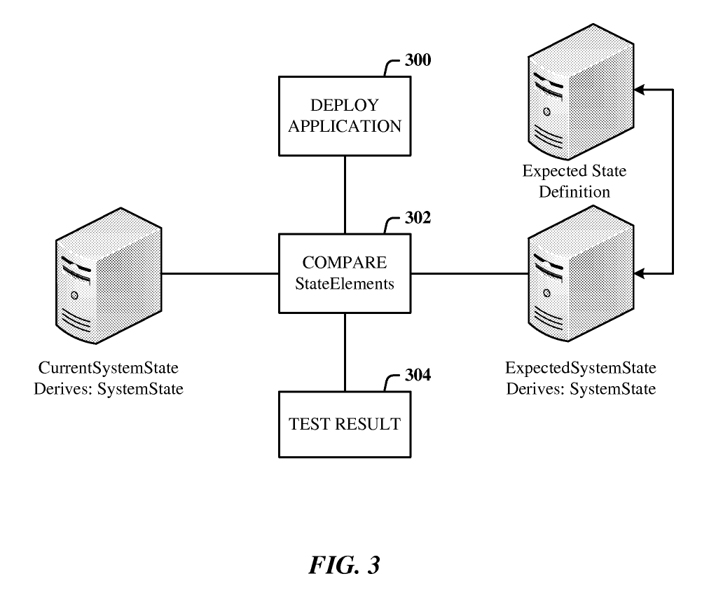

FIG. 3 illustrates a method for an exemplary test case. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

At 300, application deployment is completed. At 302, state elements related to current state and expected state are compared. At 304, a test result is output. The compare process 302 obtains the expected state from the expected state definition.

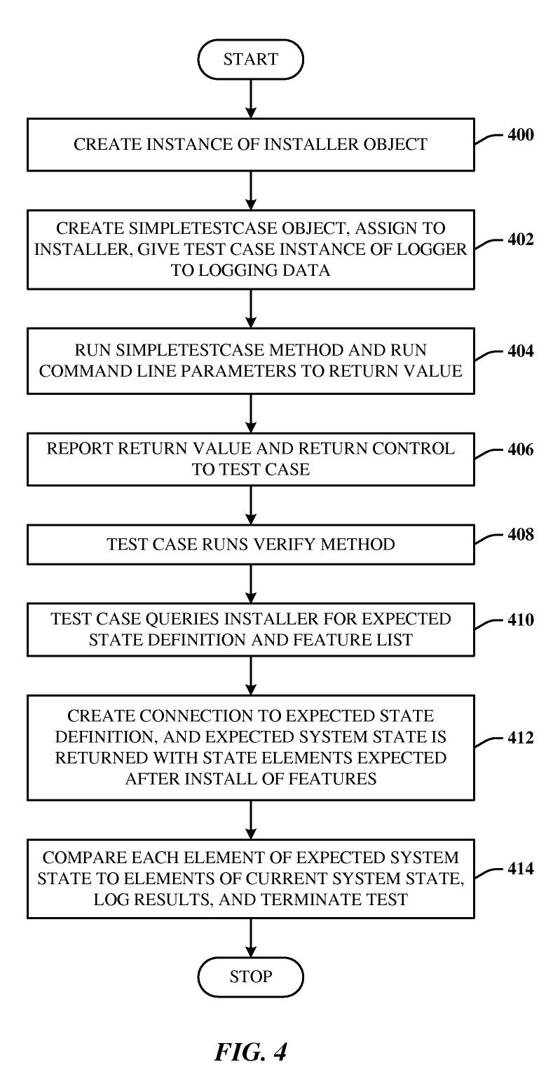

FIG. 4 illustrates a method of testing using an exemplary detailed end-to-end simple test case. This is one of many types of test cases that can be packaged for use by the end user. In one implementation, a simple test case, thorough test case and, the services and events test case are deployed in a DLL. Here, a user installs application features designated Feature1 and Feature2. At 400, the user creates an instance of an installer object. The installer object is associated with an expected state definition. Alternatively, or in combination therewith, the user can assign command line parameter(s) that will be used, and set the appropriate properties to indicate to the deployment application that Feature1 and Feature2 are expected to be installed. At 402, the user creates a SimpleTestCase object and assigns the installer/installers to the object. In other words, the test case has the ability to run several installers, and in a particular order. This is useful when a project has several applications that need to be installed in a particular order. The user then gives the test case an instance of the ILogger to be used to log the data.

When the test case gets the expected system state from the expected state definition, a call to the definition interface will perform the merging of the data retrieved from the expected state definition by multiple installers. In other words, if ItemA is installed as a result of two installers, the expected system state will report that ItemA should be installed. Similarly, if one installer installs FeatureA which installs Item1 and another installer removes FeatureB which uninstalls Item1 then the result is that the definition interface returns back that Item1 is installed. This is because FeatureA requires the file. Even if the un-installation of FeatureB was supposed to remove the file, it should not, because then FeatureA is broken.

At 404, the user runs the SimpleTestCase.Run( ) method, and once the method is launched, the command line parameters are run to generate a return value. At 406, when the resulting process completes the return value is reported and control returns back to the test case. At 408, the test case then runs the Verify( ) method. At 410, the test case queries the installer for the expected state definition information and feature list. At 412, a connection is created with the expected state definition, and an expected system state is returned that contains the state elements that are expected after Feature1 and Feature2 are installed. At 414, each element in the expected system state is then compared to the current system state, the results are logged, and the test terminates.

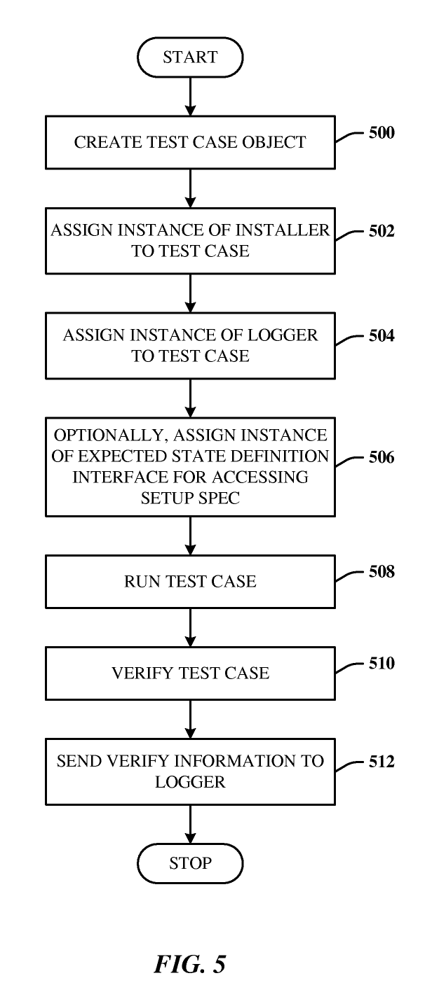

FIG. 5 illustrates a general test case method. At 500, a test case object is created, which derives an abstract base class SetupTest. At 502, an instance of an installer is assigned to the test case. This is facilitated by attaching a expected state definition interface to the installer that tells the installer where to find relative expected state definition information on the features to be deployed. At this time, features that will be added/modified/removed via the installer are defined. At 504, an instance of a logger is assigned to the test case. At 506, optionally, an instance of the expected state definition interface can be assigned. At 508, the test case is run. At 510, the test case is verified. At 512, the verify information is sent to the logger.

For deployment testing, it is not enough to know that a feature was installed. Verification includes verifying that features and products can also be uninstalled as well. To accomplish feature uninstall verification, each state element includes a state property. The state of each element can be designated as installed, uninstalled, or irrelevant. When the installer application is used as the deployment mechanism to uninstall a feature, the installer queries for the same state element list that it would have if the installer installed the feature, except that the installer now passes a flag to indicate that the feature was uninstalled. This then marks each element as uninstalled instead of installed.

If a situation exists where an installer installs a feature that expects a state element to be installed and another feature expects the state element to be uninstalled, the verification architecture assumes that the element should be installed regardless of how many features expect it to be uninstalled. The system state can only have one instance of an element, and can default to installed if one of the features requires it to be installed.

An example of when a file may be left on the machine is when the installer writes a log file and the uninstaller may not delete this file. The state element can contain an ExistsOnUninstall property that if flagged requires that the state element remain on the machine when the feature is uninstalled.

From a high level, maintainability is straightforward. Following is a description of issues that the verification architecture can address in setup testing.

Oftentimes there can be changes that occur during setup that the user may not care about. For example, a parallel process (e.g., unrelated to setup) may make changes to a % temp % directory and in a thorough test case all of those files would be flagged as errors. In another example, the installer makes numerous changes to the registry on its own behalf. Thus, these state elements can be excluded from the test results.

A state element can be excluded either implicitly or explicitly. Each element has a “State” property (e.g., install/uninstall/irrelevant). When this value is set to irrelevant the test will not fail if the state element changes. System state can be queried to find out if a SystemState item has a particular element explicitly set. When requesting the system state to provide an element, a state element will always be returned, even if the element is not explicitly set. A system state compare method goes through the following process if an element does not match the ExpectedSystemState. The method checks if the StateElement and the ExpectedStateElement match; if not, the method then checks if the StateElement is explicitly set to irrelevant (in which case the state element will not fail). If not explicitly set, the method checks if the parent is explicitly set; if so, the method then checks if the parent has been set to ignore children. If the parent is found, then the flag “ExcludeChildren” is verified. If the parent was not found or if the ExcludeChildren was not checked, then the test case will fail.

Additionally, the state elements can contain properties that are not desired to be checked. When an element is retrieved from system state that represents a current machine (either CurrentSystemState or RemoteSystemState) the element is fully populated. All of the properties of that element are filled. However, it may not be desirable to monitor if a property changed from day to day (e.g., file size) but it may be desirable to monitor the remaining properties.

To solve this issue, each state element type contains two dictionaries. One dictionary is static and contains a list of all of the “potential” properties that an element of that type could have, along with the element type (used to maintain type safety for comparison methods). The other dictionary contains the property names along with the property values for each element. If a property is not checked, the property is not set on the element. For example, assume StateElementA comes from the CurrentSystemState and is fully populated with all of its properties, and StateElementB comes from the expected but only has Name, ParentName, and Type (minimum requirements for an element). Thus, only the three properties of Name, ParentName, and Type will be considered in the comparison. This also has the side effect of allowing values such as “empty string” and NULL to be checked when the values are valid. The above process is performed using a compare method of the state element.

With respect to unpredictable or unwanted state element properties, oftentimes it is desirable to verify a value, where most of the value is predictable but a portion of the value is not (e.g., a GUID that is generated at install time). Two methods are provided to manage properties that are either only known at runtime or are not predictable at all. The first method is through test case variables. The expected state definition defines a pair of strings that can be used to mark that a particular string is to be used as a token. A token can be used to represent any value that is known only at runtime.

At the beginning of the test case, the SetupTest populates a token lookup table. By default the token lookup table contains environment variables; however, other test information (e.g., build number) can be added as well. When the ExpectedSystemState is generated the state elements with the tokens are replaced by the values stored in the token table before the values are saved in the ExpectedSystemState. Note that test cases are not required to use the tokens, but where implemented, the token lookup table is populated and utilized.

Another option is to use regular expressions. Values that should be described using regular expressions (e.g., random GUIDs) can be marked in the front of the string by the tag “<REGEX>”. This tag is used by verification architecture to indicate that a regular expression exists in the string and is used to improve performance by not having to traverse every string to determine if the regular expression exists. Secondly, the tags <RX> and </RX> surround the regular expression in the string. This is taken into account during the state element comparison and passes if the actual string matches the regular expression.

The above token table and use of regular expressions can be utilized against strings or a structure of strings such as string[ ]. This is because any property other than these is not able to benefit from the regular expression or string replacement (which the tokens provide) as explicit code may need to be written. Additionally, it makes the data easier to manage in the explorer.

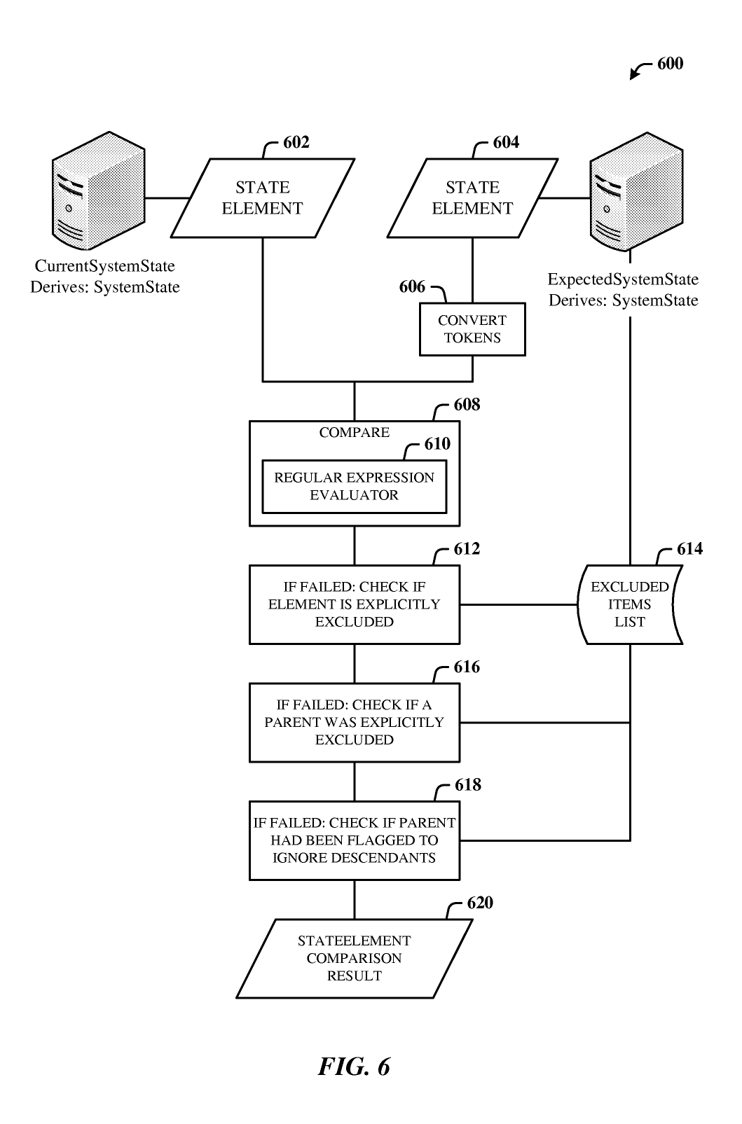

FIG. 6 illustrates a detailed test case method of comparing state elements using excluded items. At 602, a state element associated with the CurrentSystemState is retrieved. At 604, a state element associated with the ExpectedSystemState is retrieved. At 606, tokens are converted by replacing the tokens with values passed by the deploy setup test. At 608, a compare operation is performed. The compare can be performed using a regular expression evaluator 610 to evaluate for regular expressions in the string. This employs the tags described above to prevent unnecessary traversal if properly marked by checking to see if the <RegEx> tag exists at the beginning of either of the strings, and then proceeds, if true.

At 612, if the compare failed, a check is performed to determine if the element is explicitly excluded, as listed in an excluded items list 614. If not explicitly included in the excluded items list 614, flow is to 616 to check if a parent, grandparent, great grandparent, etc., was explicitly excluded, as listed in the excluded items list 614. If this again fails, flow is to 618 to check if the parent, grandparent, great grandparent, etc., had been flagged to ignore descendants, as determined from the excluded items list 614. Ultimately, at 620, the comparison result is output.

Some strings may not be case sensitive such as a file name. The test passes if the two file names vary by case alone. To handle this, a static list is included in the base class to prevent repeating of the data multiple times.

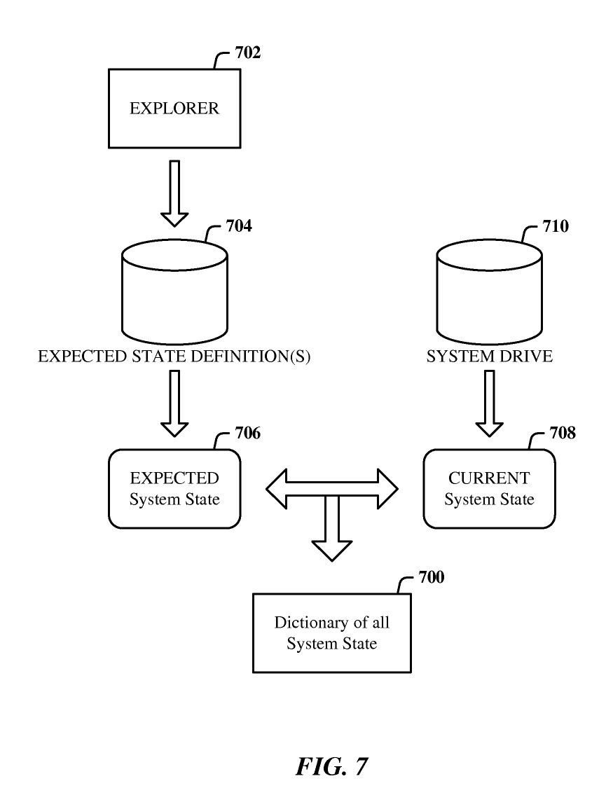

FIG. 7 illustrates that the comparison of expected and current system state is saved as a dictionary 700 (or collection) of system state. The explorer 702 is used to manage the expected state definitions 704 from which the expected system state 706 is derived. The current system state 708 represents data on the system drive 710, for example. Each key in the dictionary 700 is a StateElementType. Retrieving the value of the key will result in a lost of state elements of the StateElementType.

The explorer 702 is a standalone executable that provides a UI to securely manage (e.g., modify) expected state definitions (e.g., expected state definition(s) 204 and expected state definition 704) used by the verification architecture. The explorer 702 uses shared objects to read and write the expected state definition part information into well-formed XML files (feeder files) based on a predefined XML schema. An item that implements the definition interface is the expected state definition. The definition interface facilitates the retrieval of data from any entity that can store data, such as a database, file, or an actual machine.

Another aspect of the explorer 702 is the change detection where the functionality from the auditing library can be leveraged to scan a system prior and after an install action and then post the differences. The change detection can also be performed by scanning two areas and then comparing the changes (between time A and time B), without an install action inbetween (e.g., as in an install that is expected to rollback the changes). This is equivalent to a thorough test case without the comparison of expected system state. This produces a feeder file (e.g., an XML document) that represents the changes and which can be imported into the database. This feature has application to media verification, setup spec creation, etc., for example.

The expected state definition 704 can be an XML file or other type of data storage (e.g., SQL) that contains the information defined by the expected state definition regarding, optionally, some or all of the files, directories, registries, services and metabase entries, and all other state element types. The expected state definition 704 is a collection of all state elements for a particular software product. The database includes information on the computing system in the form of entries that can be verified such as operating system and processor type (e.g., x86, x64, etc). In order to retrieve the expected system state 706, the expected state definition 704 takes into account the machine configuration (e.g., OS, locale, architecture, etc.) and relevant application/features which are installed or have been removed from the machine, and generates a system state based on the elements associated with that configuration.

The expected state definition 704 can contain at least the following different parts: a file list—a list of all file properties; a directory list—a list of all directory properties; a registry list—a list of all registry properties; a service list—a list of all services properties; a metabase list—a list of all IIS metabase properties; and a verify file content list—a list of all files which contents will be modified during setup. However, the different parts are not a requirement to gain the benefits of the disclosed architecture, but constitute one implementation thereof.

The expected state definition 704 can also provide information regarding requirements for each spec part entry. For example, a requirement can be that a file should be only installed on an x86 Windows XP Pro platform. A requirement can also provide that the information related to a file should be ignored upon install, modify, repair and/or uninstall.

The explorer 702 manages state elements by tying the elements with context. A feature item is the combination of the state element with its context. Context can be defined as information associated to the state element that makes the state element particular to a specific installation (or deployment) such as a product.

The explorer 702 can include the following features: a tool for generating feeder files, open multiple instances of an expected state definition or system state, a query builder, a feedback mechanism, data explorer and administration functionality. Feeder files are defined XML-structured files that contain a set of state elements to be imported by the explorer 702. Generate Feeder File is a method that provides all changes in the current system caused by the installer of a product. All the changes are saved in the feeder file according to a predefined structure (the schema) with name and location provided by the user. An Import Feeder File method imports the feeder files into the explorer 702 assigning the state elements of the feeder file to product, feature and platform group(s). An Export Feeder Files method is a mechanism that exports the state elements of a product, feature and platform group(s) to a feeder file.

The explorer 702 can open one or many instances of an expected state definition, a CurrentSystemState or a remote SystemState, for example. Again, this includes any object that implements the definition interface. This then allows the information to be migrated from a current system state or remote system state to an expected state definition. Under some circumstances, the definition interface may throw an exception if an attempt is made to add or remove an element.

The query builder is a GUI that provides a query mechanism to query for one or more state elements from an expected state definition. The builder provides choices of Logical Operator, Field Name, Operator logical and Value. Other choices can be provided. The user can manipulate these choices and filter the results displayed in the data explorer. The user can save queries (e.g., in a proprietary format) and open saved queries to be run. There can be certain constraints imposed that make the query builder work; for example, the first clause in the query should be the product name.

The data explorer is a GUI that displays the results of a query initiated by the query builder. The user can sort elements by the column, choose the columns to be displayed, single or bulk edit state elements, add new state element to a product, feature and platform group(s), compare two state elements, compare platform group state elements, copy from one platform group to another, add state elements to a platform group, and remove state elements from a group, for example. If an element type does not have a particular property associated with the column, the explorer UI can display “not applicable” (or N/A).

The administration UI of the explorer exposes a set of forms so the general information of products and features can be stored. The administration UI provides the management of this general information by allowing the addition, change and removal of every piece of information. These are used to organize the elements.

The administration UI manages the OS name information that comprises a platform. The name matches the descriptive OS name provided by a call (e.g., WMI) to the OS. The administration UI also manages the processor architectures that will comprise a platform. The name matches the descriptive processor architecture name (e.g., provided a Microsoft .Net Framework). The administration UI manages the languages that will comprise a platform. The name can be configured to match a 3-letter acronym for languages. The administration UI also manages the platforms on which a test will be run. A platform is comprised of the platform name, processor architecture, product language, OS and OS Language.

A platform group is a way of grouping a set of platforms that have the same state elements. The group is a way of minimizing redundant information and significantly improves maintenance time. Every state element is associated with one or more platform. A platform may or may not be associated with a platform group.

By design, a product is an installer and can (but not required to) be named after the product name (e.g., Microsoft Speech Server (mss32.msi)).

Products usually have a set of features that are installed by the product (e.g., SERVER, ADMIN, DOCS, etc.). A feature can be of one of three types: setup, exclusion and external component. The setup feature is a regular product feature and is used in the setup verification process. A feature is the smallest product component that can be deployed. The exclusion list feature is treated in a different way—if a state element belongs to this type of feature, test will ignore it explicitly. The external component feature is a feature that hosts state elements that are installed by the product but might belong to a different product (e.g., there can be a DLL that is shared by a word processor application and a server speech application). Using this feature can ensure that a state element is not removed if the element is required by another application.

Tokens allow predictable dynamic details about state elements to be inserted into the state element at runtime. An example when this is used is when files are expected to be installed on the root drive. The root drive is not necessarily known at design time so a token can be inserted into the file name at runtime via the token lookup table which is defined in the auditing library.

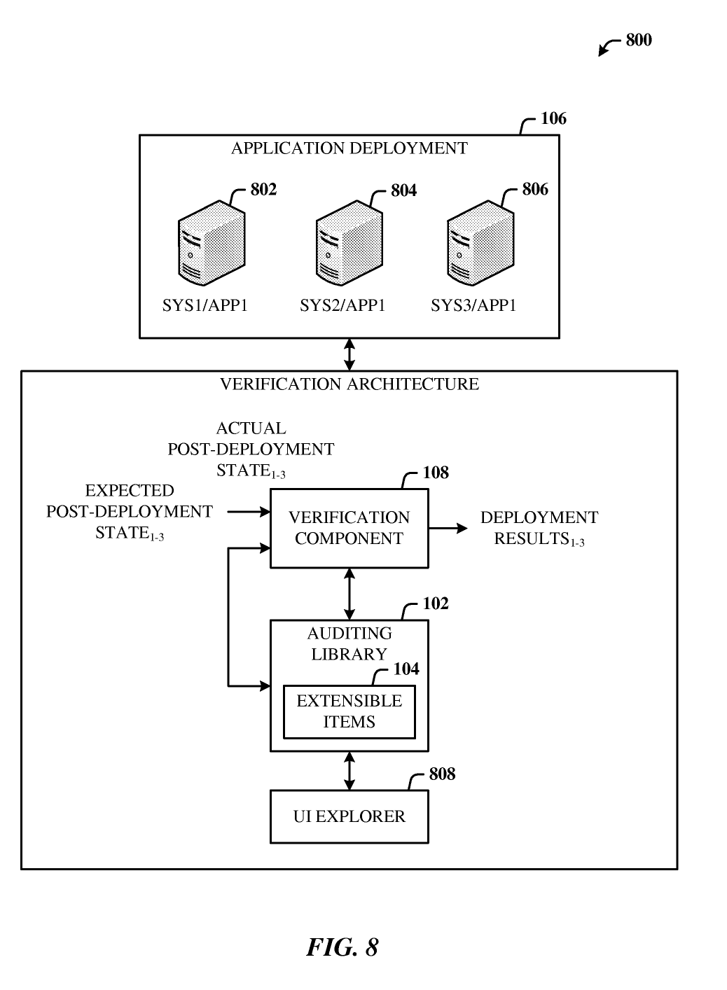

FIG. 8 illustrates a system 800 for managing application test deployment across multiple different platforms. Here, test deployment is performed on a group of three computing systems each having different hardware and/or software characteristics (e.g., CPU architectures, operating systems, etc.). For example, a first system 802 can be an x86 16-bit processor architecture and first operating system on which the application is being tested, a second system 804 can be an x86 32-bit processor architecture and second operating system on which the application is being tested, and a third system 806 can be an x86 64-bit processor architecture and third operating system on which the application is being tested.

Expected state elements can be assigned for system items to be tested and verified as part of the deployment process. Elements can be grouped (associating a state element with multiple platforms) since it can be the case that many of the same state elements can occur on two or more computing systems. Thus, a UI explorer 808 facilitates managing the extensible items (state elements) and configuring all aspects to the setup test, such as assigning expected state element values, properties for install, uninstall, modify and repair processes, for example.

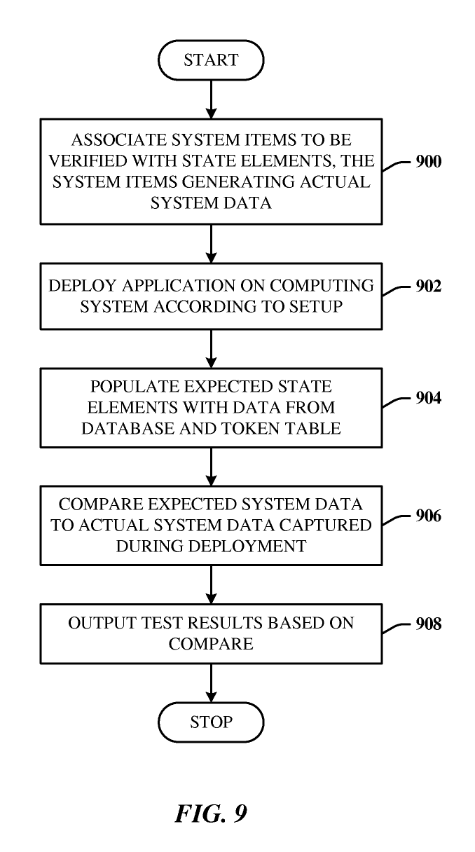

FIG. 9 illustrates a method of verifying application deployment on a computing system. At 900, state elements are associated with system items, the system items to be verified during an application deployment and generating actual system data. At 902, the application is deployed according to a test setup. At 904, expected state elements are populated with expected system data from the database and token table. At 906, the expected system data is compared to actual system data captured during the deployment. At 908, test results are output based on the comparison.

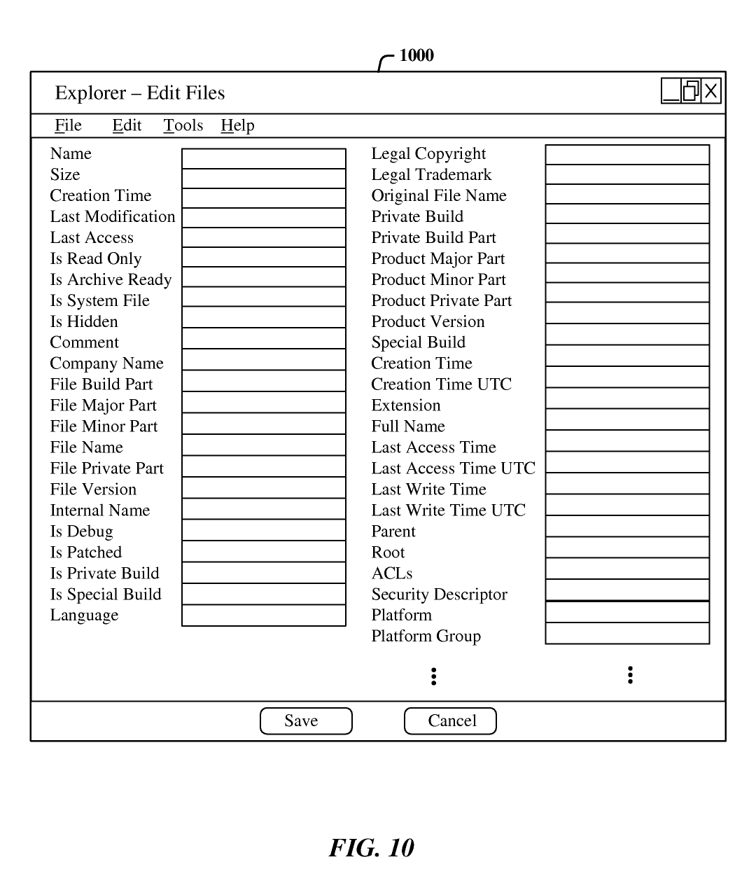

FIG. 10 illustrates an exemplary explorer UI tool 1000 for interacting and configuring the verification components. Other implementations can differ, as desired. The SystemState object contains a collection for each type of item that is used to identify the state of a system. The items include file, directory, registry key, registry value and service. The UI lists some of the properties that can be exposed for each of these items.

The initial expected state definition information can be populated via change detection, select from the system, path entry, or importing from a text file. For change detection, the explorer captures the difference before and after an install action is completed and the differences will be included into a new definition (or feeder) file. Considering that the product is installed in the machine, the explorer can browse through the local system and select all the files that comprise the expected state definition. The property information can also be obtained during this browse process. The user can also enter the path for the part item (e.g., file, directory) where the explorer will gather all the properties to create the setup spec. When using a text file for importing expected state definition information, the text file can be formed by a dir/s/b from the root of the application redirected to a file.

Each item in the expected state definition database, whether a file, directory, or registry item, can be marked as excluded. These excluded items are ignored during the test case.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

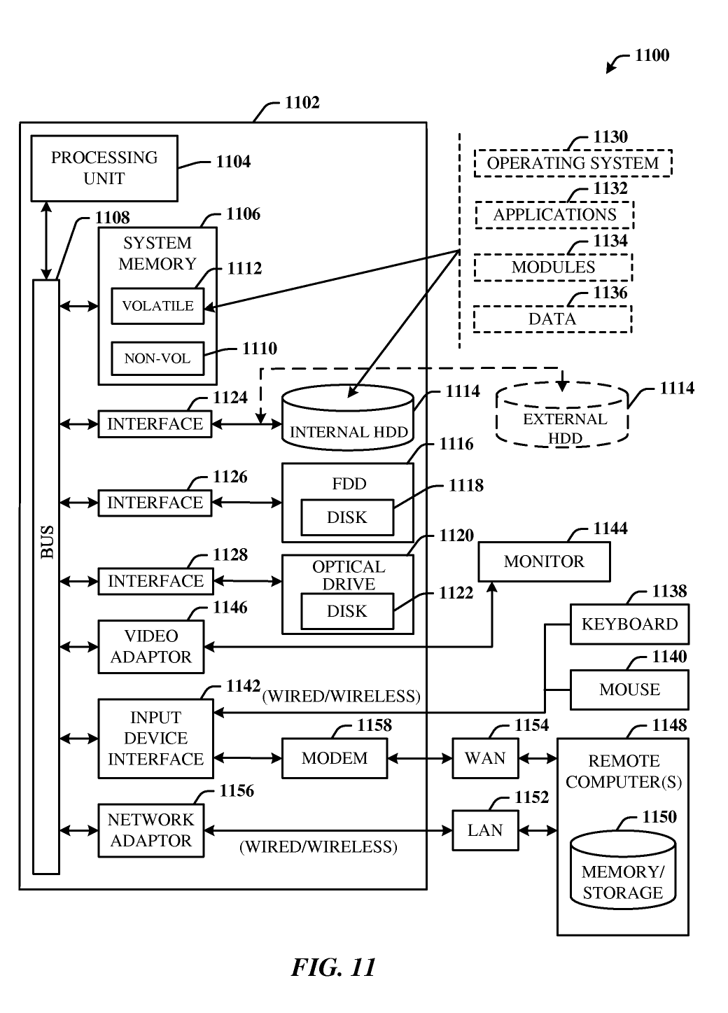

Referring now to FIG. 11, there is illustrated a block diagram of a computing system 1100 operable to execute application test deployment and verification in accordance with the disclosed architecture. In order to provide additional context for various aspects thereof, FIG. 11 and the following discussion are intended to provide a brief, general description of a suitable computing system 1100 in which the various aspects can be implemented. Note that in the context of the disclosed architecture, not all pieces or components of the computing system 1100 are needed. For example, the computing system 1100 may or may not have a network port, a hard disk drive, monitor, etc. The state elements are intended to be sufficiently generic such that no single computer implementation must be employed (e.g., no peripherals are required, etc.). While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary computing system 1100 for implementing various aspects includes a computer 1102 having a processing unit 1104, a system memory 1106 and a system bus 1108. The system bus 1108 provides an interface for system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 can include non-volatile memory (NON-VOL) 1110 and/or volatile memory 1112 (e.g., random access memory (RAM)). A basic input/output system (BIOS) can be stored in the non-volatile memory 1110 (e.g., ROM, EPROM, EEPROM, etc.), which BIOS stores the basic routines that help to transfer information between elements within the computer 1102, such as during start-up. The volatile memory 1112 can also include a high-speed RAM such as static RAM for caching data.

The computer 1102 further includes an internal hard disk drive (HDD) 1114 (e.g., EIDE, SATA), which internal HDD 1114 may also be configured for external use in a suitable chassis, a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as a DVD). The HDD 1114, FDD 1116 and optical disk drive 1120 can be connected to the system bus 1108 by a HDD interface 1124, an FDD interface 1126 and an optical drive interface 1128, respectively. The HDD interface 1124 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1112, including an operating system 1130, one or more application programs 1132, other program modules 1134, and program data 1136. The one or more application programs 1132, other program modules 1134, and program data 1136 can include the auditing library 102, extensible items 104, verification component 108, state component 112, actual post-deployment state, expected post-deployment state 110, deployment results 114, results component 116, logging component 118, explorer 702, expected state definition 704, system drive data 710, expected and current system state (706 and 708), dictionary 700, and UI 808, for example.

All or portions of the operating system, applications, modules, and/or data can also be cached in the volatile memory 1112. It is to be appreciated that the disclosed architecture can be implemented with various commercially available operating systems or combinations of operating systems.

A user can enter commands and information into the computer 1102 through one or more wire/wireless input devices, for example, a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces such as a parallel port, IEEE 1394 serial port, a game port, a USB port, an IR interface, etc.

A monitor 1144 or other type of display device is also connected to the system bus 1108 via an interface, such as a video adaptor 1146. In addition to the monitor 1144, a computer typically includes other peripheral output devices (not shown), such as speakers, printers, etc.

The computer 1102 may operate in a networked environment using logical connections via wire and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wire/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the LAN 1152 through a wire and/or wireless communication network interface or adaptor 1156. The adaptor 1156 can facilitate wire and/or wireless communications to the LAN 1152, which may also include a wireless access point disposed thereon for communicating with the wireless functionality of the adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wire and/or wireless device, is connected to the system bus 1108 via the input device interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented verification system, comprising:
an auditing library of extensible items for automating verification of deployment of an application; and
a verification component for verifying the deployment by comparing actual post-deployment state to expected post-deployment state.

2. The system of claim 1, wherein the deployment includes a log of messages associated with one or more of application install, application feature modification after install, repair, or application uninstall.

3. The system of claim 1, wherein the library includes an item that represents system state at a particular point in time.

4. The system of claim 1, wherein the library includes items that store expected data against which system state is compared.

5. The system of claim 1, wherein the library includes a logging object for logging messages related to the deployment.

6. The system of claim 1, wherein the library includes an installer object that runs one or more setup applications, and tracks state of application features related to install, modification, repair and delete.

7. The system of claim 1, wherein the verification component runs a setup test and combines one or more items of the auditing library to verify the deployment.

8. The system of claim 1, further comprising a user interface (UI) tool for viewing and managing information defined by an expected state definition.

9. The system of claim 8, wherein the UI tool manages the information by associating state elements to context of a specific deployment.

10. A computer-implemented verification system, comprising:
an auditing library of extensible items for automating verification of a test deployment of an application;
a UI for configuring expected post-deployment data for the test deployment; and
a verification component for verifying the test deployment by running a setup test and combining one or more items of the auditing library to verify the test deployment.

11. The system of claim 10, further comprising a logging component for logging messages associated with deployment processes of the application, the deployment processes related to install, modify, repair and uninstall of application files.

12. The system of claim 10, further comprising a query tool for searching for results that include one or more state elements, filtering the results, and displaying the results.

13. A computer-implemented method of verifying application deployment on a computing system, comprising:
associating state elements with system items, the system items to be verified during an application deployment and generating actual system data;
populating expected state elements with expected system data, the expected state elements corresponding to the state elements;
deploying the application according to a test setup;
comparing the expected system data to the actual system data captured during the deployment; and
outputting test results based on the comparison.

14. The method of claim 13, further comprising running a test setup that retrieves the expected data and detects if software features associated with the set of state elements were installed and removed.

15. The method of claim 13, further comprising running a test setup that detects changes in the set of state elements that occurred between two system scans, and compares the changes to the expected data to detect install of unexpected software.

16. The method of claim 13, further comprising tagging a property of a state element that indicates an associated application feature was installed or uninstalled and processing properties of the state elements as a measure of deployment quality.

17. The method of claim 13, further comprising excluding one or more of state elements, properties of the state elements, or children of a parent directory from testing during the test setup.

18. The method of claim 13, further comprising processing a property of a current state element based on properties populated in an expected state element.

19. The method of claim 13, further comprising employing tokens or regular expressions to account for unpredictable or unwanted properties of the state elements.

20. The method of claim 13, further comprising running the test setup across multiple platforms from an administrator user interface.
